(19) United States
(12) Patent Application Publication
(10) Pub. No.: US 2008/0121410 A1
(43) Pub. Date: May 29, 2008

(54) MAIN DUCT WITH INNER DUCT AND METHOD FOR PRODUCING THE SAME

(76) Inventors: Thomas Richard McCall, Knoxville, TN (US); Juan Manuel Urquiza Gonzalez Cocio, Knoxville, TN (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/425,257

(22) Filed: Jun. 20, 2006

(51) Int. Cl. H02G 3/04

(52) U.S. Cl. 174/95; 29/592

(57) ABSTRACT

The present invention provides a duct system adapted to receive and provide a protective housing for a cable. The duct system includes a main duct having a substantially tubular shape and an outer and inner wall, and an inner duct having a substantially tubular shape, an outer and inner wall, and a cross-sectional diameter smaller than that of the main duct. At least a portion of the inner duct is fixedly attached to the inner wall of the main duct.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### BACKGROUND OF THE INVENTION

This invention relates generally to inner ducts that facilitate the installation of communication and power transmission cables in existing conduits and, more particularly, to inner ducts that are adhered in a constant plane to the inner surface of a main duct so as to provide a reasonably straight, untwisting geometry between the two ducts.

Fiber optic cables are widely used as a substitute for much of the copper wire heretofore used in the telecommunications industry. Fiber optic cables or “light guide” cables are preferred over traditional copper wires in that they are capable of transmitting a substantially greater amount of information while occupying a substantially smaller amount of space. The fiber optic cables are typically encased in a polyethylene sheath that acts as a protective coating for the fiber optic elements, which are formed from glass.

The cables are installed in inner ducts that have been placed in existing, typically subterranean, conduits from which the copper cables have been removed, or in inner ducts buried directly in the ground. The inner ducts are used to provide for substantially low friction placement of, and a hazardless environment for, the fiber optic cables.

It has been discovered, however, that the process of installing a smaller duct within a main duct poses certain difficulties, particularly when the main duct contains existing cable (a process called an override). The existing cable within the duct generally exists in a loose and undefined manner, causing the inner duct to become entangled in the existing cable. Due to this difficulty, inserting an inner duct into a main duct containing existing cable can be time consuming and in some cases, the insertion of the inner duct may be limited to short lengths of main duct.

The present invention provides an improved inner duct and a method for producing an improved inner duct within a main duct.

### BRIEF SUMMARY OF THE INVENTION

The present invention provides a duct system adapted to receive and provide a protective housing for a cable. The duct system includes a main duct having a substantially tubular shape and an outer and inner wall, and an inner duct having a substantially tubular shape, an outer and inner wall, and a cross-sectional diameter smaller than that of the main duct. At least a portion of the inner duct is fixedly attached to the inner wall of the main duct.

The present invention further provides a duct system wherein the inner duct is fixedly attached to the inner wall of the main duct along a constant plane so as to achieve a substantially straight geometry between the inner duct and the main duct.

The present invention further provides a duct system as described above, wherein the duct system is comprised of high density polyethylene.

The present invention further provides a duct system as described above, wherein the duct system comprises a lubricous agent, such as, for example, Teflon®, silicone impregnated polyethylene, graphite impregnated polyethylene, and combinations thereof.

The present invention further provides a duct system as described above, further including a rib portion having first and second ends, the first end of the rib portion being attached to the inner wall of the main duct, and the second end of the rib portion being attached to the outer wall of the inner duct.

The present invention further provides a method for producing a duct system that includes the steps of providing a first duct, extruding a second duct, the second duct having a cross-sectional diameter greater than that of the first duct, and adhering at least a portion of the outer wall of the first duct to at least a portion of the inner wall of the second duct. The invention further provides the step of cooling the first and second ducts so that a strong bond is formed therebetween.

### BRIEF DESCRIPTION OF THE DRAWINGS

FIG. 1 is a cross-sectional view of a duct system constructed in accordance with the teachings of the present invention.

FIG. 2 is a cross-sectional view of an alternative embodiment of a duct system constructed in accordance with the teachings of the present invention.

### DETAILED DESCRIPTION OF THE INVENTION

Turning now to the drawings, wherein like numerals indicate like parts, the numeral 10 refers generally to a system including a main duct and an inner duct, wherein the inner duct is preformed within the main duct in accordance with the teachings of the present invention.

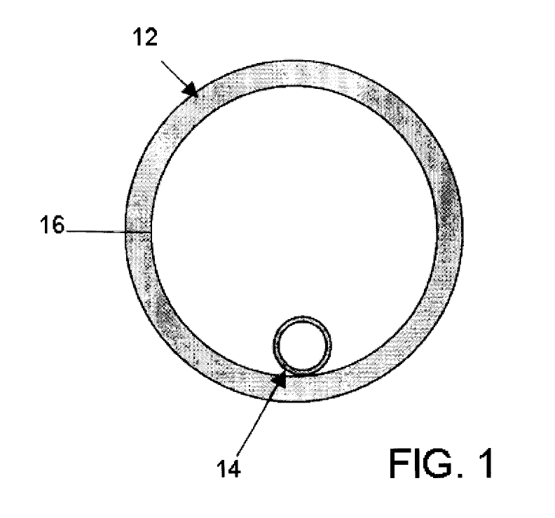

FIG. 1 is a cross-sectional view of a main duct 12 having an inner duct 14 preformed therein as taught by the present invention, the inner duct having a cross-sectional diameter less than that of the main duct. Inner duct 14 is preferably inserted into main duct 12 during extrusion of main duct 12 such that inner duct 14 is adhered to the interior wall 16 of main duct 12 while main duct 12 is still hot and tacky. The process by which inner duct 14 is formed and adhered to main duct 12 is described in greater detail below. Inner duct 14 is preferably adhered to main duct 12 in a constant plane so as to achieve a reasonably straight and untwisting geometry of the space between the ducts.

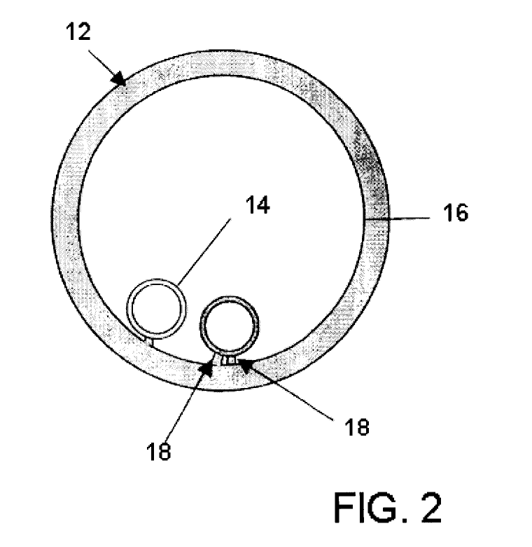

FIG. 2 provides a cross-sectional view of an alternative embodiment of a main duct 12 having an inner duct 14 formed therein, inner duct 14 being raised off of interior wall 16 of main duct 12 by ribs 18. This aids in dissipation of heat wherein at least a portion of the outer wall of said inner duct is fixedly generated during initial placement of cable within inner duct 14, subsequent use, or removal and replacement of cable within inner duct 14. Although FIG. 2 depicts main duct 12 as having a single inner duct 14 and two ribs 18, it is contemplated that multiple inner ducts 14 may be included within a single main duct 12, and further that each inner duct 14 may have only a single rib 18 or may have more than two ribs 18 shown in the figure. In embodiments having multiple inner ducts 14, some or all of inner ducts 14 may also be adhered directly to interior wall 16 of main duct 12.

A prefferred method of manufacturing a main duct 12 having an inner duct 14 included therin, as described above and shown in the figures, is now presented. First, a microduct is provided for use as inner duct 14. The microduct can be obtained from any source, or may be manufactured by a user of the present invention prior to manufacturing the main duct for use in the improved duct system of the present invention. The microduct is manufactured, for example, by extrusion processes well known in the art. Once the microduct is provided, the microduct is wound onto a drunk, which is then mounted on a device that is easily rotated, such as a reel stand or truck or trailer that has a straight bar to allow the reel to spin freely or with assistance form a mechanized drive. The device is then positioned alongside an extruder used for extrusion of the main duct. The extrusion of main duct 12 is then started. Through a suitable tooling, the microduct is allowed to pass and enter into main duct 12 while main duct 12 is still hot and tacky enough to permit permanent sticking of the micro duct onto it. For example, during the extrusion process of the larger duct (the outer or main duct 12) the inner duct 14 is pushed through the center of the tooling that is forming main duct 12 so that it enter main duct 12 while main duct 12 is still hot and tacky. This allows inner duct 14 to obtain a positive contact with main duct 12 and stick to the inside of main duct 12. Once the two ducts adhere to one another, they preferably pass through cooling tanks in order to achieve a strong and permanent bond between them. Once formation of main duct 12 having the improved inner duct 14 is complete, the improved duct system may be wound onto a coiler of appropriate length.

The improved main duct and inner duct system of the present invention is preferably constructed from high-density polyethylene (HDPE), though any suitable material may be used, including various other plastics or ploymers, as well as fire-retardent materials. The material used to form the ducts of the present invetion may also be impregnated or otherwise associated with a lubricous agent to lower the coefficient of friction of the duct walls and thereby facilitate the pulling of fiber optic or other cables therethrough. In order to achieve this effect, it is necessary only to impregnate or otherwise associate the interior walls of main duct 12 or inner duct 14 with a lubricous agent. Suitable materials for the interior walls include Teflon®, silicone-impregnated polyethylene, graphite-impregnated polyethylene, and the like. In addition, the materials used to product the ducts of the present invention may carry pigments, stabilizers, or other additives commonly known in the art.

The detailed description set forth above is provided to aid those skilled in the art in practicing the present invention. The invention described and claimed herein, however, is not to be limited in scope by the specific embodiments disclosed because these embodiments are intended to be illustrative of several aspects of the invention. Any equivalent embodiments are intended to be within the scope of the present invention. Various modifications of the invention which do no depart from the spirit or scope of the present invention, in addition to those shown and described herein, will become apparent to those skilled in the art from the foregoing description. Such modifications are also intended to fall within the scope of the appended claims.

1. A duct for receiving and providing a protective housing for a cable, the duct comprising:
a main duct being substantially tubular in shape and having an outer wall and an inner wall defining and interior space therein; and
an inner duct being substantially tubular in shape and having a cross-sectional diameter less than a cross-sectional diameter of said main duct, the inner duct having an outer wall and an inner wall defining an interior space therein,
wherein at least a portion of the outer wall of said inner duct is fixedly attached to the inner wall of said main duct.

2. The duct system according to claim 1 wherein said inner duct is fixedly attached to the inner wall of said main duct along a constant plane so as to achieve a substantially straight geometry between said inner duct and said main duct.

3. The duct system according to claim 1 wherein said duct comprises high density polyethylene.

4. The duct system according to claim 1 wherein said duct comprises a lubricous agent.

5. The duct system according to claim 4 wherein said lubricous agent is selected from the group consisting of Teflon®, silicone impregnated polyethylene, graphite impregnated polyethylene, and combinations thereof.

6. The duct system according to claim 1 further comprising at least one rib portion, said rib portion having a first end and a second end, the first end of said rib portion fixedly attached to the inner wall of said main duct and the second end of said rib portion fixedly attached to the outer wall of said inner duct, wherein said rib portion prevents the outer wall of said inner duct from contacting the inner wall of said main duct.

7. A method for producing a duct system for use with fiber optic and other cables, the method comprising the steps of
a) providing a first duct;
b) extruding a second duct, said second duct having a cross-sectional diameter greater than the cross-sectional diameter of the first duct; and
c) contacting at least a portion of an outer wall of said first duct to at least a portion of and inner wall of said second duct during extrusion of said second duct such that the interior wall of said second duct is tacky, allowing said first duct to adhere thereto.

8. The method according to claim 7 further comprising the step of:
d) cooling said first and second ducts such that a strong bond is formed therebetween.

9. A method for producing a duct system for use with fiber optic and other cables, the method comprising the steps of
a) providing a first duct, said first duct having at least one rib portion extending from a outer wall thereof;
b) extruding a second duct, said second duct having a cross-sectional diameter greater than the cross-sectional diameter of the first duct; and
c) contacting said at least one rib portion of said first duct to at least a portion of and inner wall of said second duct during extrusion of said second duct such that the interior wall of said second duct is tacky, allowing said first duct to adhere thereto.

10. The method according to claim 9 further comprising the step of:
d) cooling said first and second ducts such that a strong bond is formed therebetween.
